(19) United States
(12) Patent Application Publication
(10) Pub. No.: US 2004/0244188 A1
(43) Pub. Date: Dec. 9, 2004

(54) Heavy cable crimping block

(76) Inventor: Harold D. Hutchinson, Oxnard, CA (US)

Correspondence Address: TROJAN LAW OFFICES, 9250 WILSHIRE BLVD, SUITE 325, BEVERLY HILLS, CA, 90212

(21) Appl. No.: 10/757,379

(22) Filed: Jan. 13, 2004

Related U.S. Application Data
(63) Continuation-in-part of application No. 10/457,031, filed on Jun. 5, 2003, now abandoned.

(51) Int. Cl. B23P 19/00

(52) U.S. Cl. 29/753; 29/761; 29/749

(57) ABSTRACT

A crimping block device comprised of a crimping base block and an upper crimping block constructed to mate with the base. The crimping block base is provided with a plurality of ribs that engage a plurality of crimping troughs on the surface of the crimping block. When the upper crimping block is placed on the base crimping block, the ribs are centered over the crimping troughs. Bolts on each end of the upper crimping block allow it to be screwed down tightly against the base crimping block with the ribs engaging a socket on a connector to securely and completely crush the socket around the cable. Each crimping trough is different in size to accommodate different sized cables. An alternate embodiment includes a handle to be attached to the crimping block device for ease of maneuverability which can be removed when space will not allow the use of a handle.

This Application is a Continuation-In-Part of application Ser. No. 10/457,031, filed Jun. 5, 2003, and Continuation-In-Part of Application Serial No. 29/177,340, filed Mar. 6, 2003.

### BACKGROUND OF THE INVENTION

1. Field of the Invention

This invention relates to tools for crimping connectors on cables and more particularly relates to a heavy-duty crimping blocks for crimping connectors on heavy cables.

2. Background Information

There are a wide variety of crimping tools for crimping terminals, lugs, and connectors on wires or cables and for splicing cables. Cables are comprised of an assembly of conductive strands which are twisted to form a core and have an insulating coating. In some cases several twisted cores may be combined to form heavy-duty cables. Such heavy-duty cables find their use where large currents are present such as in aircraft and other equipment that draw heavy currents.

Crimping tools can be used to crimp and connect to an end of cable or can be used for crimpable cable splice connectors to join adjacent ends of cables. Crimping means the connector has a crimpable end forming a socket to receive the end of the cable. The crimping tool then applies substantial pressure to the socket end of the connector. The crimping tool mashes the socket end of the connector on the cable until it tightly fits around the cable holding the connector firmly joining the end of the connector to the end of the cable.

One problem with present splicers is they are not suitable for use in small cramped spaces. Some of them have a pair of handles pivotally connected to a pair of jaws. Opening and closing the handles applies a force to the crimping portion of the jaws to crimp a connector on the end of a cable. Further a very large force is required to crimp these cable connectors on heavy-duty cables. These types of crimping tools are unsuitable for small spaces such as under the hoods of aircraft. Other type of crimping tools employ an adjustable handle and a crimping pin movable towards an anvil for crushing the cable connector and the end of the cable between the anvil and the crimping end.

However these devices are not found to be suitable for use in the small or closely confined spaces such as under the hood of an aircraft engine.

It is therefore one object of the present invention to provide crimping blocks that is small enough and simple enough to use in confined spaces such as under the hood of an aircraft engine.

Yet another object of the present invention is to provide a crimping tool for crimping connectors on heavy-duty cable that is adaptable to a variety of different cable sizes.

Yet another object of the present invention is to provide a heavy-duty cable crimping blocks that can easily provide a substantial force on the end of a connector crushing it firmly and tightly around the end of a heavy-duty cable.

Still another object of the present invention is to provide a heavy-duty cable crimping block in which substantial force can be applied to crush a connector around the end of a cable by bolts in opposite ends of crimping blocks that when tightened down crush the connector against the end of the cable.

Yet another object of the present invention is to provide heavy-duty cable crimping blocks having one blocks with a plurality of crimping troughs or grooves for receiving the end of a cable and a second block mating with the first block having a plurality of ribs with the plateaus that engage the troughs to crush a connector onto the end of a cable.

Still another object of the present invention is to provide heavy-duty cable crimping blocks having a first base crimping block with a plurality of ribs and an upper crimping block that has additional crimping troughs on an upper surface allowing the upper crimping block to be reversed.

Still another object of the present invention is applied to heavy-duty cable crimping block having a removable handle that can be attached to either end of the cable crimping blocks.

### BRIEF DESCRIPTION OF THE INVENTION

This invention relates to crimping devices for crimping connectors on cables and more particularly relates to crimping blocks for crimping connectors on heavy-duty cables.

Connectors or terminals are connected to wires and cables by fitting them on the end of a wire or cable and then crimping connector to firmly and tightly secure it to the end of a cable. A socket on the terminal or splicing connector is placed over the end of the cable which is first cut square and the insulation stripped an amount approximately equal to about the socket depth. The end of the cable is inserted in the terminal socket and then placed in a crimping tool having a groove or notch sometimes referred to as an anvil. The crimping tool having a pin with a surface that will engage the groove is then closed crushing the socket on the terminal tightly around the end of the cable.

In the present invention the crimping device is comprised of a base block having a plurality of ribs or ridges spaced apart across the width of the block. These ribs have plateaus forming flat crushing surfaces for crimping a connector socket on the end of a heavy-duty cable.

A second upper block is constructed to mate with the base block and has plurality of crosswise troughs or notches. The troughs are spaced apart on an undersurface of the upper crimping block. Preferably there are a plurality of these troughs of different sizes. Each trough is sized to have a radius that is equal to the radius of a selected standard gage cable. In the embodiment disclosed herein, there are four equally spaced troughs to match four different gage cables. The upper cable crimping block has troughs spaced so that the ridges on the base block intercept each groove approximately at its center when the crimping tool is closed.

To crimp a connector onto the socket on a connector or terminal, a stripped end of a heavy-duty cable is first inserted in the connector or terminal socket and placed in one of the appropriately sized troughs of the upper crimping block. The base crimping block and upper crimping block are then drawn together by bolts passing through the upper crimping block into threaded holes in respective ends of the base crimping block until the crimping tool is closed. This draws the plateau on the crimping ribs of the base block up against the connector mounted on the cable crushing the connector socket against the groove in the upper crimping block tightly squeezing and crimping the connector on the end of the cable.

An optional preferred feature of the invention is the inclusion of a plurality of troughs on an upper surface of the upper crimping block to increase the range of cables that can be crimped with the tool. Preferably in the upper surface of the upper crimping block, there are four additional crimping troughs each sized to a particular diameter cable. That is, the radius of the grooves is approximately equal to a particular radius or gage of cable. This provides up to eight different sized cables that can be suitably mounted and crimped in the crimping block. To use the upper crimping block troughs in the upper surface, the upper crimping block is reversed on the lower crimping block so that the crimping ribs in the lower crimping block engage the grooves as described previously. Crimping is accomplished also as described hereinabove.

Still another option of the present invention is to provide a handle for the tool that allows the tool to be easily held while a connector is being crimped on a cable. The crimping tool can be used with or without the handle. If there is sufficient space, the handle may be mounted by a threaded bolt shaft which engages a threaded hole in the end of one of the base or upper crimping blocks. Preferably the threaded socket is in the upper crimping block which is generally larger than the lower crimping block. Also to allow the flexibility of using the tool from either end, a second socket is provided in the opposite end of upper crimping block so that the tool may be reversed.

The above and other objects, advantages, and novel features of the invention will be more fully understood from the following detailed description and the accompanying drawings, in which:

### BRIEF DESCRIPTION OF THE DRAWINGS

FIG. 1 is an isometric view of a crimping device constructed according to the invention.

FIG. 2 is a side elevation of the crimping device of FIG. 1.

FIG. 3 is an end view of the crimping device of FIG. 3.

FIG. 4 is a top view of the crimping device.

FIG. 5 is a bottom view of the crimping device.

FIG. 6 is an isometric view of the crimping tool with the upper crimping block reversed to accommodate additional size or gage of cables.

FIG. 7 is an isometric view of an optional embodiment which includes a handle for manipulating the crimping tool.

FIG. 8 is an isometric view illustrating use of the crimping device of FIG. 7 with a handle.

FIG. 9 is an isometric view of the crimping device illustrating use with a clamping tool.

### DETAILED DESCRIPTION OF THE INVENTION

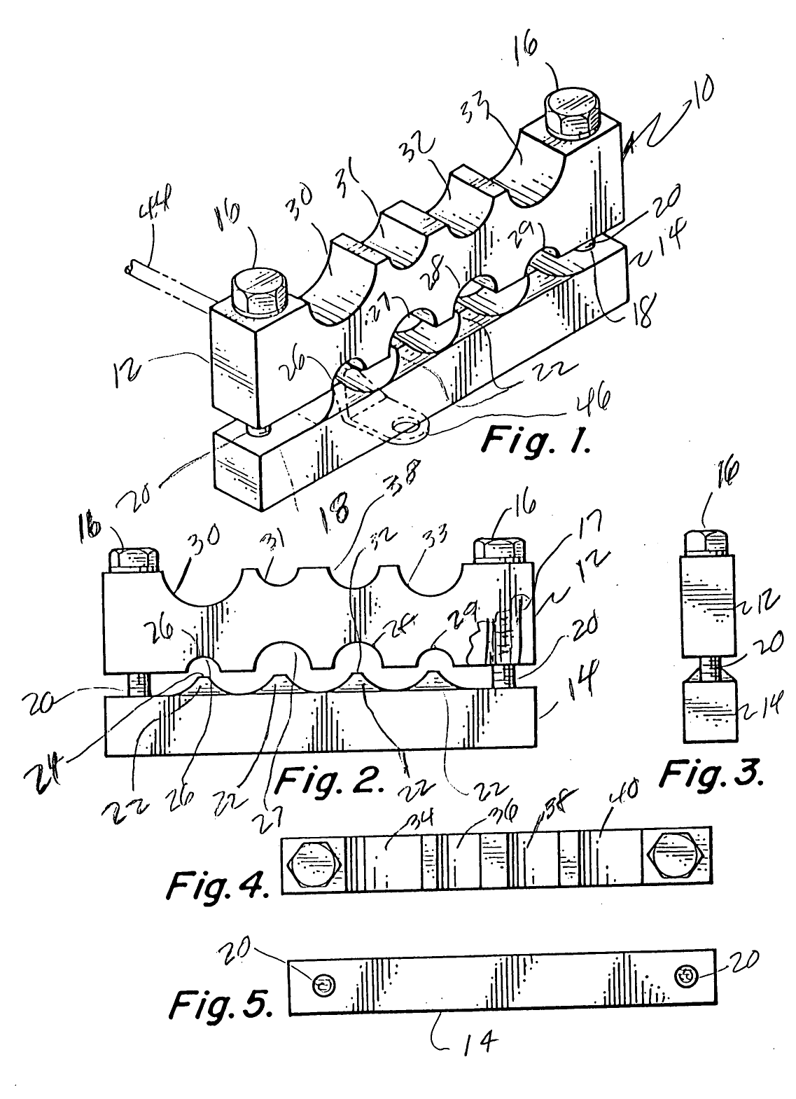

A crimping block device 10 constructed according to the invention is shown in the isometric view of FIG. 1. Crimping device 10 is comprised of upper crimping block 12 and base crimping block 14. Hex-head bolts 16 on each end of crimping block device 10 extend through bores 17 in upper crimping block 12 into threaded bores 18 in each respective end of base crimping block 14. Bores 17 at each end of upper crimping block 12 could be straight through bores but also could be threaded if desired to retain bolts 16 when base crimping block 14 is separated from upper crimping block 12. Preferably bores 17 in each end of upper crimping block 12 are larger than the diameter of threaded shaft 20 of bolt 16 to allow the reversal of upper crimping block 12 to be easily and quickly made.

Preferably bores 17 in each end of upper crimping block 12 are larger than the threaded shaft 12 on bolts 16 so that they pass easily through the upper crimping block 12 into the threaded bore 18 in base crimping block 14. Optionally bores 17 in upper crimping block 10 could be threaded for the purpose of retaining bolt 16 when upper crimping block 12 is separated from base crimping block 14 as described previously.

The construction of upper crimping block 12 and base crimping block 14 is illustrated in FIGS. 2 through 5. Base crimping block 14 is rectangular in shape and has a plurality of ribs 22 each having a flat surface or plateau 24 for engaging and crushing or crimping the connector of a terminal or a splicing connector. Each rib 22 across the width of base block 14 has a plateau or flat surface 24 crushing the connector when the upper crimping block 12 is closed on the lower crimping block as will be described hereinafter. Both upper crimping block 12 and base crimping block 14 are preferably made from steel.

Upper crimping block 12 is approximately the same rectangular shape as base crimping block 14 and has a plurality of troughs 26, 27, 28, 29, 30, 31, 32, and 33 that are preferably in the shape of arcuate semi-circular grooves for receiving the end of a cable inserted in a socket of a terminal or a splicing connector. Optionally the troughs 27 through 33 could be other shapes such as V-shaped if desired. Upper crimping block 12 when positioned above base block 14 has axis of each trough approximately centered over plateaus 24 on ribs 22. Thus when upper crimping block 12 is closed down on base crimping block 14, plateaus 24 of ribs 22 intersect each trough. Preferably ribs 22 have a height that is only slightly less than the depth of each of the troughs 26, 28, 30, 32, 34, 36, 38, and 40. Each rib 22 can be of the same height or can be constructed to match the size or depth of each trough 26 through 33.

The unique feature of the crimping block tool 10 is that it is adaptable to various size cables by varying the size of troughs 26 through 33 and making upper crimping block 12 reversible. That is, by unscrewing bolt 16 allowing upper crimping block 12 to be separated from base crimping block 14, it can be reversed and the crimping troughs 30 through 33 used. Further while crimping troughs 26 through 33 are shown as random in FIG. 2, they could be consecutive with each crimping trough slightly increasing in size either from left to right or from right to left. Also preferably each trough would have a marking adjacent to trough indicating the preferred size of cable the trough is to be used for.

As was described previously, crimping troughs 26 through 33 are all slightly different in size to accommodate different size cables. As shown, troughs 26 vary in size from approximately ¼ of an inch to ½ an inch while troughs 30 through 33 vary in size from approximately ⅜ to ¾ of an inch. Troughs 26 through 33 could also be at metric sizes if desired. Troughs 26 through 33 while shown as semi-circular could be different shapes such as oval, V-shaped, etc. Also as stated previously, ribs or ridges 22 can vary in height according to the respective trough 22 through 33 they are to engage. Thus while ribs 22 are shown at equal height in FIG. 2, they could be of varying height if desired.

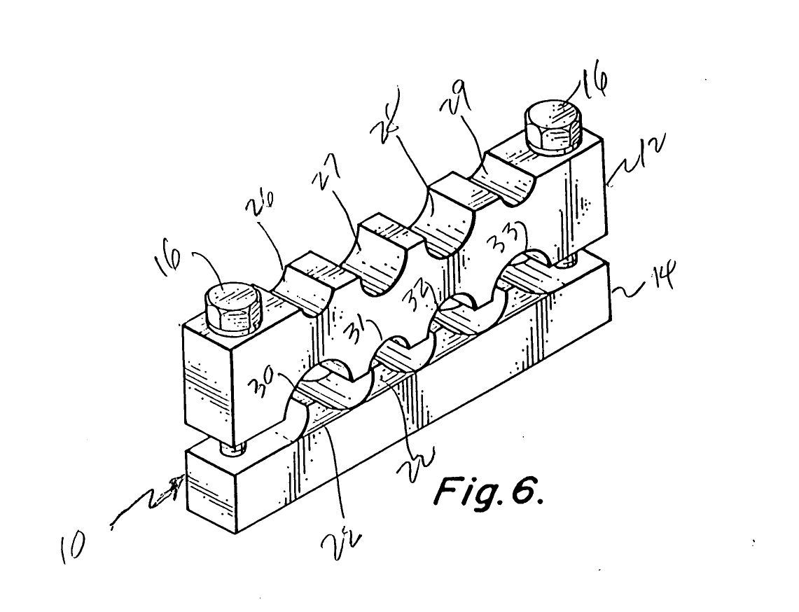

FIG. 6 illustrates the crimping block tool 10 of FIG. 1 with the upper crimping block 12 reversed. Also, each crimping trough 26 through 33 is approximately semi-circular and has a radius approximately equal to the radius of the cable to which the terminal or connector is being spliced. Markings (not shown) are preferably provided by engraving or some other suitable means on the upper crimping block adjacent each trough 30 through 33 indicating the correct trough to use for the particularly size cable being crimped.

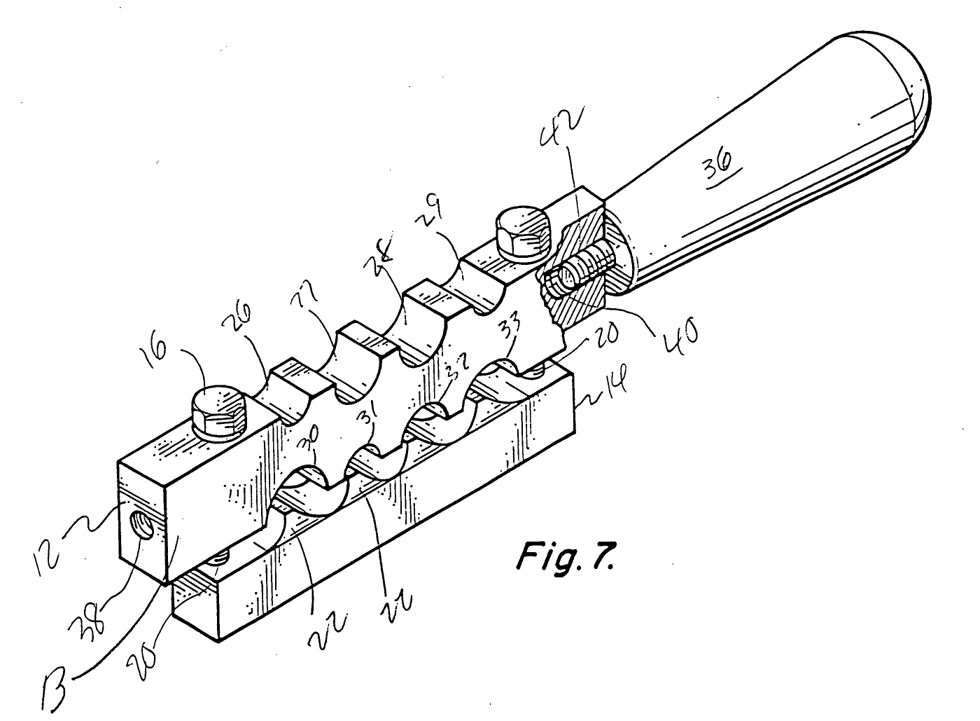

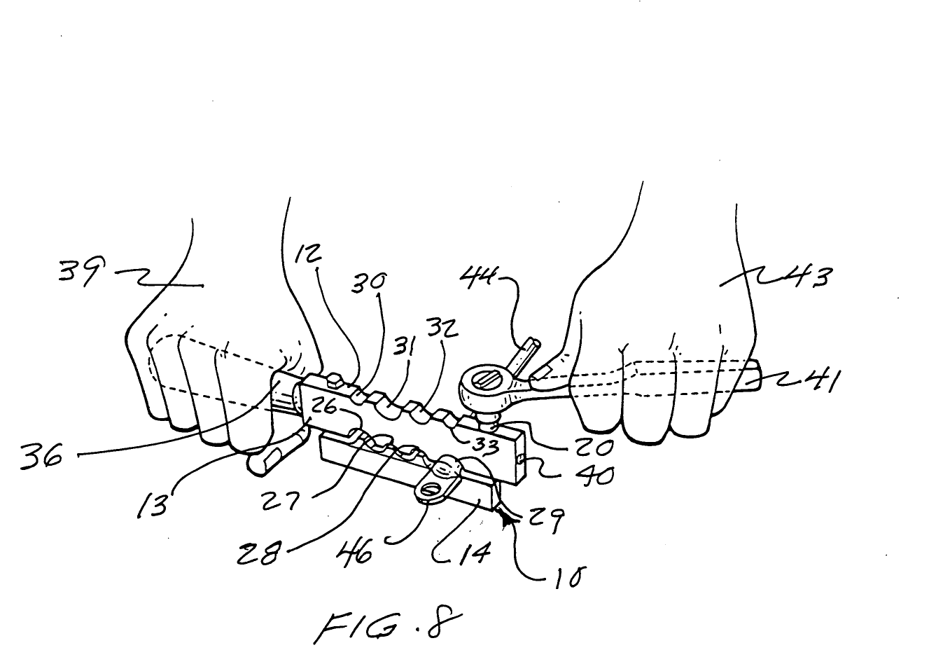

An alternate but preferred embodiment includes a handle 36 as illustrated in FIG. 7. For this purpose upper crimping block 12 is slightly longer than base crimping block 14 to accommodate threaded bores 38 and 40 at each end. Handle 36 made of any suitable material such as wood or metal has a threaded shaft 42 that threads into threaded bores 38 through 40 on either end of upper crimping block 12. Where space is not at a premium, handle 36 can be used with the crimping device in the field. Further in some “tight quarters” where space is at a premium, handle 36 may easily be removed by unscrewing shaft 42 from bore 38 or 40.

It should also be noted that upper crimping block 12 of FIG. 7 is longer than base crimping block 14. This results in flat areas 13 on each side of both ends of upper crimping block 12. Flats 13 provide a gripping surface for use in some situations when handle may not be convenient as will be described in greater detail hereinafter.

One method of using crimping block tool 10 is illustrated in FIG. 1. A cable 44 is cut to length and insulation stripped off a short portion on the end equal to approximately the depth of a socket on the end of terminal or connector 46. Cable 44 is then inserted into the socket on the end of terminal 46 and the assembly placed in the appropriate trough 26 through 33 in crimping device 10. Preferably the connector in the end of connector socket and the end of cable 14 are centered in one of the crimping troughs such as crimping top 26. Bolts 16 are then tightened down to force plateau 24 of the first rib 22 into trough or semi-circular groove 26 until the connector socket is crushed around the end of cable 44. This results in connector 46 being securely fastened to the strip end of cable 44.

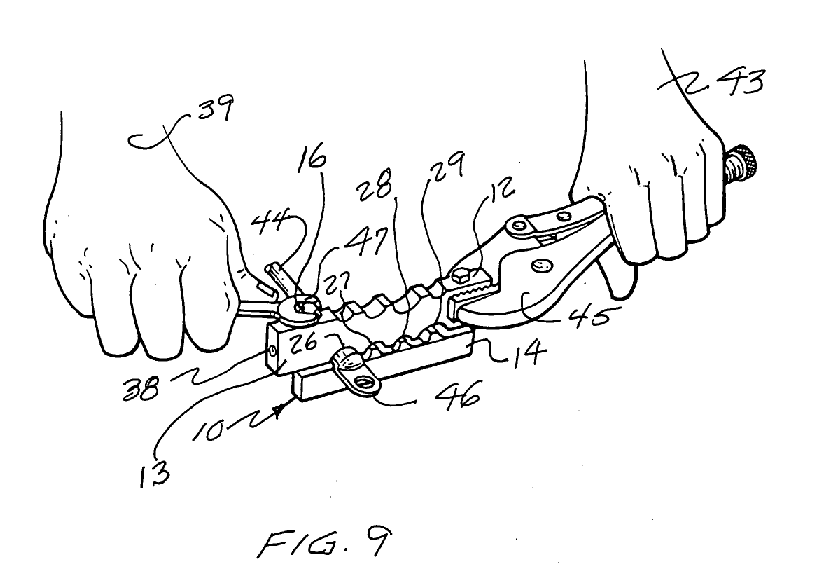

The use of crimping block 10 with handle 36 is illustrated in FIG. 8. A cable 44 with a lug 46 is seated in the appropriate trough 29 according to the size of gage of cable 44. Handle 36 is attached to upper crimping block 12 by screwing threaded shaft 42 into aperture 38, preferably at the end farthest from cable 44 to gain the greatest leverage if possible. While handle 36 is held by hand 39, a tool 41 such as a ratchet wrench, or any other suitable tool for gripping bolt head 16 is rotated by the other hand 43 to draw crimping tool 10 closed securely crimping lug 46 on cable 44. Of course handle 36 can be attached to either end of upper crimping block 12 and depends upon where the tool is being used and how much space is available.

An alternative method of using crimping block 10 is illustrated in FIG. 9. Elongated upper crimping block 12 with flats 13 allow either end to be held by a clamp such as clamping tool 45 known as a vise grip while an open end wrench is used on bolt head 16. Cable 44 with lug 46 is first positioned in the appropriate trough 26 while clamping tool is locked on flats 13 furthermost from cable 44 to obtain the greatest leverage. While clamping tool 45 is shown clamping flats 13 and extending outward along the length of crimping block 10, it can of course be clamped at any angle on flats 13 on either end of upper crimping block 12. It can be from parallel as shown or perpendicular or at any angle in between. Bolts 20 at each end would be tightened down until lug 46 is crushed securely fastening it to an end of cable 44.

It should also be noted that flats 13 on both sides of either end of upper crimping block 12 are of sufficient length that the crimping tool can be held by a hand 39 without the use of handle 36 or clamping tool 45. This arrangement will allow the tool to still be used in cramped or tight spaces where handle 36 or clamping tool 45 would not fit.

Thus there has been described a simple to construct and easy to use crimping block device that can be used to crimp terminals or splice connectors on the ends of a cable. The crimping block tool is simple in design and small enough to be used in very tight spaces such as under the hood of an aircraft or other areas where the usual crimping tools having long handles or complex mechanism may not be used. This tool is simply and easy to use by placing the connector on the cable fitting it to the proper crimping trough and closing the tool by cranking bolts 16 down until upper crimping block 12 is pressed down on base crimping block 14. This allows crimping ribs 22 to severely and securely crush or crimp the connector socket onto the end of a cable.

This invention is not to be limited by the embodiment shown in the drawings and described in the description which is given by way of example and not of limitation, but only in accordance with the scope of the appended claims.

What is claimed is:

1. A crimping device for crimping connectors on variable sized cables comprising;
a first crimping block having a plurality of crimping ribs for engaging a connector fitted on the end of a cable;
a second crimping block having a plurality of crimping troughs on a surface adapted to mate with said ribs on said first crimping block;
a bolt passing through a bore on each respective end of said second crimping block into threaded bores in each respective end of said first crimping block;
whereby a connector may be attached to a cable by placing a cable and connector in a respective crimping trough and tightening down said bolts until a respective crimping rib engages a respective crimping trough crushing and securely crimping said connector on an end of said cable.

2. The crimping device according to claim 1 in which said first and second crimping blocks are rectangular.

3. The crimping device according to claim 4 in which said first and second crimping blocks are approximately equal in size.

4. The crimping device according to claim 1 in which each of said plurality of ribs each have a plateau, said ribs having a length that is approximately equal to the width of said first rectangular block.

5. The crimping device according to claim 2 in which the height of each of said plurality of ribs is selected to nearly fully engage a respective trough in said second crimping block.

6. The crimping device according to claim 1 in which said second crimping block has a plurality of crimping troughs in a surface opposite the surface adapted to mate with said first crimping blocks.

7. The crimping device according to claim 6 in which the crimping troughs vary in size to accommodate different size cables.

8. The crimping device according to claim 7 in which said plurality of crimping troughs in a surface that mates with said first crimping block doubles the amount of crimping troughs; whereby double the number of cables can be crimped.

9. The crimping device according to claim 1 in which said bores in respective ends of said second crimping block are threaded; whereby said bolts are retimed when said second crimping block is separated from said first crimping block.

10. The crimping device according to claim 1 including a handle extending from one end of said crimping device for holding said crimping block in position while a connector is being crimped on the end of a cable.

11. The crimping device according to claim 9 in which said handle is removable from said crimping device.

12. The crimping device according to claim 10 in which said handle has a threaded shaft on one end; and said second crimping block having a threaded bore on an end for removably receiving said threaded shaft on said handle.

13. The crimping device according to claim 11 in which said second crimping block has threaded bores on opposite ends;
whereby said handle may be removably attached to either end of said crimping block.

14. The crimping device according to claim 2 in which said second crimping block has flat areas on at least one end for gripping the crimping device.

15. The crimping device according to claim 14 in which said second crimping block is longer than said first crimping block to provide said flat areas on both sides of said second crimping block on either end; whereby said crimping device can be gripped by a hand or a clamping tool.
